(19) United States
(12) Patent Application Publication
(10) Pub. No.: US 2026/0061844 A1
(43) Pub. Date: Mar. 5, 2026

(54) LAMINATED PANE WITH MASKING LAYER AND ELECTRICALLY SWITCHABLE FUNCTIONAL FILM

(71) Applicant: SAINT-GOBAIN SEKURIT FRANCE, Thourotte (FR)

(72) Inventors: Michele CAPPUCCILLI, HERZOGENRATH (DE); Adil JAAFAR, HERZOGENRATH (DE); Florence JACQUES, HERZOGENRATH (DE); Michael LABROT, HERZOGENRATH (DE)

(21) Appl. No.: 19/107,271

(22) PCT Filed: Aug. 25, 2023
(86) PCT No.: PCT/EP2023/073318

§ 371 Date: Feb. 27, 2025

(30) Foreign Application Priority Data
Aug. 30, 2022 (EP) 22192946.6

(51) Int. Cl. B60K 35/23; B32B 17/10; G02B 27/01

(52) U.S. Cl. CPC B60K 35/23; B32B 17/10036; B32B 17/10348; B32B 17/10513; G02B 27/0101; B32B 2605/00; B60K 2360/785

(57) ABSTRACT

A laminated pane includes an outer pane with an outer-side surface and an interior-side surface, a thermoplastic intermediate layer, an inner pane with an outer-side surface and an interior-side surface, a masking layer arranged between the outer and inner panes, an electrically switchable functional film switchable between a first switching state with lower optical transmission and a second switching state with higher optical transmission by applying an operating voltage. The electrically switchable functional film is arranged, when viewed perpendicularly through the laminated pane, directly adjacent to the masking layer or overlapping an opening in the masking layer. The masking layer and the electrically switchable functional film are arranged in one region of the laminated pane. The laminated pane includes a reflective layer for reflecting light on the outer-side surface and/or on the interior-side surface of the inner pane.

The invention relates to a laminated pane comprising a partially applied reflective layer and a masking layer in combination with an electrically switchable functional film, a method for the production and use thereof, and a projection arrangement.

Modern automobiles are increasingly equipped with so-called head-up displays (HUD's). With a projector, typically in the region of the dashboard, images are projected onto the windshield, reflected there, and perceived by the driver as a virtual image behind the windshield. Thus, important information can be projected into the field of vision of the driver, for example, the current travel speed, navigation messages or warnings that the driver can perceive without having to turn his gaze away from the road. Head-up displays can accordingly contribute substantially to increasing traffic safety.

However, head-up displays often have the problem that the region of the windshield which is provided for reflection of the light projected by the projector has to have a high transparency of generally at least 70%. The reflected light of the projector is thus overlaid with light from the external environment, which, depending on the light conditions, can lead to a reduction in contrast of the virtual image and thus to a poorer visual perception for the driver. A sufficient visual perception of, in particular, safety-relevant information such as lane assistance, speed display or rotational speed of the motor should be ensured in all weather and light conditions. It would thus be desirable to have a projection arrangement which is based on the head-up display technology in which no undesired secondary images occur and the arrangement of which is relatively easy to accomplish with good visibility with sufficient brightness and contrast of the displayed image information. In order to achieve this, it is necessary to increase the contrast in the reflection region of the windshield. The contrast increase can be achieved, for example, by the background of the reflection region being largely or completely opaque. Such solutions require that a reflective layer is applied only in a locally limited region of the windshield.

The application of metallic coatings to glass panes is usually achieved by sputtering, in particular magnetron sputtering. During sputtering, atoms are released from a target by bombarding it with ions. By means of physical vapor deposition, the glass pane is coated with the atoms released from the target in an evacuated chamber. The atoms move, guided by electric fields, through the chamber toward the glass pane. They move from the cathode, on which the target is arranged, toward the anode. Due to the arrangement of the glass pane between the cathode and the anode, a layer forms on the glass pane. In the case of magnetron sputtering, an additional magnetic field is arranged behind the cathode, which leads to faster layer growth and a denser, i.e., less porous, layer. Methods in which sputtering is used to coat glass panes are known, for example, from WO 9900528 A1, DE 10126868 C1 and WO 2017198363 A1.

Magnetron sputtering is also suitable for coating glass panes because, unlike many other coating technologies, it can also be used when the glass pane is curved, as is the case with panes intended for the automotive sector, for example. The selective coating of only certain surface regions can be achieved, for example, by masking the regions that are not to be coated.

Cold gas spraying is also a suitable method for coating glass panes and is a coating method generally known to a person skilled in the art in which a powder is applied to a carrier at very high speed. Methods for coating by means of cold gas spraying are known, for example, from WO 2010/003396 A1, EP 3 845685 A1 and EP 2902530 A1.

A reflective layer in the region of the masking layer allows good visibility of the virtual image with high contrast and suitable brightness. Heretofore, the dimensions of the masking layer and reflective layer have been fixed during production, so that there is no variability of the opaque region in practical application.

The object of the present invention is to provide an improved laminated pane with a partially applied reflective layer, with which the aforementioned disadvantage can be overcome. In particular, the laminated pane should be easy and reliable to manufacture in industrial series production.

The object of the present invention is achieved according to the invention by a laminated pane according to claim 1. Preferred embodiments are apparent from the dependent claims.

The laminated pane according to the invention comprises an outer pane, a thermoplastic intermediate layer, at least one masking layer, and an inner pane. The thermoplastic intermediate layer is arranged between the outer pane and the inner pane. The masking layer is arranged between the outer pane and the inner pane.

The laminated pane further comprises at least one electrically switchable functional film with a functional layer that can be switched between a first switching state with lower optical transmission and a second switching state with higher optical transmission by applying an operating voltage. According to the invention, the electrically switchable functional film is arranged, when viewed perpendicularly through the laminated pane, directly adjacent to the masking layer or overlapping an opening in the masking layer, wherein the masking layer and the switchable functional film are arranged in one region of the laminated pane.

Furthermore, the laminated pane comprises at least one reflective layer for reflecting light on the outer-side surface and/or on the interior-side surface of the inner pane, wherein the reflective layer, when viewed perpendicularly through the laminated pane, is arranged completely in the aforementioned region of the laminated pane in which the masking layer and the switchable functional film are arranged.

If the electrically switchable functional film is directly adjacent to the masking layer, the dimensions of the opaque region of the laminated pane, as defined by the masking layer, can be freely extended. The opaque region of the laminated pane is preferably extended without gaps by the electrically switchable functional film in the first switching state. If the electrically switchable functional film is arranged to overlap an opening in the masking layer, the dimension of the opaque region of the laminated pane, as defined by the masking layer, can be freely extended, wherein the opening in the masking layer can be made opaque by the electrically switchable functional film in the first switching state. For this purpose, the electrically switchable functional film completely covers the opening in the masking layer when viewed perpendicularly through the laminated pane. The electrically switchable functional film thus complements the masking layer in the first switching state in order to increase the opaque region of the laminated pane. In other words, the masking layer and the electrically switchable functional film are used in combination to freely change the size of the opaque region of the laminated pane. In the first switching state of the electrically switchable functional film, the opaque region of the laminated pane results from the combination of the opaque regions of the masking layer and the electrically switchable functional film, based on a perpendicular view through the laminated pane. In the second switching state, the opaque region of the laminated pane is created by the masking layer alone.

The electrically switchable functional film advantageously allows the dimensions of the opaque region of the laminated pane to be changed when it is in the first switching state with lower optical transmission, i.e., the opaque region is increased. On the other hand, the dimensions of the opaque region of the laminated pane can be reduced to those of the masking layer when it is in the second switching state with higher optical transmission, i.e., the opaque region of the laminated pane is reduced. In this way, the size of the opaque region of the laminated pane can be freely increased or reduced by electrically switching the electrically switchable functional film and in this way can be specifically adapted to the relevant requirements. For example, in certain driving situations of a motor vehicle, such as parking, it may be desirable to have as large a transparent region of the windshield as possible, whereas in other driving situations, for example when the vehicle is stationary or during autonomous driving, it may be desirable to display as much information as possible with high contrast, so that the opaque region should be as large as possible.

The electrically switchable functional film thus serves to increase the dimensions of the opaque region of the laminated pane when the electrically switchable functional film is in the first switching state and, on the other hand, to leave the opaque region unchanged when it is in the second switching state. For this purpose, the switchable functional film is opaque for visible light in the first switching state and transparent in the second switching state.

For the purposes of the present invention, “transparent” is understood to mean that the transmission for visible light is more than 30%. Accordingly, “opaque” is understood to mean a light transmission of less than 5%, preferably less than 1.5%, in particular 0.1% at most, for example 0%. Particularly preferably, the switchable functional film has an optical transmission of less than 1.5% in the first switching state and an optical transmission of more than 30% in the second switching state. The electrically switchable functional film is opaque in the first switching state with lower optical transparency and transparent in the second switching state with higher optical transparency.

Electrically switchable functional films whose optical transparency can be changed are well known to a person skilled in the art and are commercially available. These are generally planar electro-optical functional elements with a functional layer (active layer) between two surface electrodes, wherein the optical transparency of the functional layer can be electrically controlled. This means that the optical transparency of the functional film or functional layer can be controlled by applying an electrical voltage (operating voltage), wherein the functional layer is generally opaque without electrical voltage and transparent with electrical voltage. The applied voltage can thus be used to control the transmission of visible light through the electro-optical functional element, although such an adjustment of the optical properties generally does not allow for independent illumination of the laminated panes.

The electrical contacting of functional layers usually takes place on bus bars which are applied in the edge region of the functional layer and contact them in an electrically conductive manner. By connecting the bus bars to an external voltage source, typically via flat conductors attached to the bus bars, a voltage is applied and the functional layer is switched.

In principle, any electrically switchable functional film can be used whose optical transparency can be changed by applying an operating voltage and can be switched between an opaque switching state and a transparent switching state. The electrically switchable functional film is preferably a guest-host functional film, an electrochromic functional film, an SPD functional film or a PDLC functional film. Such functional films can be easily laminated into laminated panes.

In particular, electro-optical functional films with a functional layer based on liquid crystal, which are based on the so-called “guest-host” effect, represent an interesting possibility for realising an electro-optical switching function in a laminated pane in a simple space-saving, cost-effective and reliable manner in the application. Here and in the following, electro-optical functional films with a functional layer based on liquid crystal, which are based on the “guest-host” effect, are referred to as “guest-host functional films” for the sake of simplicity. Guest-host functional films typically comprise a nematic liquid crystal (the host) which is provided with an additive (the guest), wherein dichroic dye molecules, which absorb light anisotropically, are used, for example, as an additive. Since the molecules of the additive have an elongated form, their orientation can be controlled by the orientation of the molecules of the liquid crystal, i.e. the host, which is achieved in practice by applying an electrical field to the liquid crystal. In this way, the optical transparency of the guest-host functional film can be controlled very precisely by an external electric field. Guest-host functional films having a functional layer made of a liquid crystalline material with an embedded additive are well known to a person skilled in the art, so that they do not need to be discussed in more detail here. Guest-host functional films, for example under the description “light control film,” are commercially available, for example, from Dai Nippon Printing Co. Ltd., Japan, under the product name LCF005 (EU).

Electrochromic functional films are known, for example, from US20120026573 A1 and WO 2012007334 A1. SPD functional films (SPD=suspended particle device) are known, for example, from EP 0876608 B1 and WO 2011033313 A1. PDLC functional films (PDLC=polymer dispersed liquid crystal) are known, for example, from DE 102008026339 A1. Such functional films are frequently used in the industrial series production of laminated panes and are well known to a person skilled in the art, so that they do not need to be discussed in more detail here.

The laminated pane according to the invention is preferably provided in a window opening of a vehicle for separating the interior from the external environment. Within the meaning of the invention, the term “inner pane” refers to the pane of the laminated pane facing the vehicle interior. Outer pane is understood to mean the pane facing the external environment.

The laminated pane has an, in particular, upper edge and a lower edge and two side edges extending between them. Upper edge is understood to mean the edge intended to point upwards in the installed position. Lower edge is understood to mean the edge intended to point downward in the installed position. In the case of a windshield, the upper edge is often also referred to as the roof edge and the lower edge is referred to as the motor edge.

The outer pane and the inner pane in each case have an outer-side and an interior-side surface and a circumferential side edge extending between them. In the sense of the invention, the outer-side surface is understood to mean the main surface which is intended to face the external environment when installed. In the sense of the invention, the interior-side surface is understood to mean the main surface which is intended to face the interior when installed. The interior-side surface of the outer pane and the outer-side surface of the inner pane face one another and are connected to one another by the thermoplastic intermediate layer. The outer-side surface of the outer pane is designated as side I. The interior-side surface of the outer pane is designated as side II. The outer-side surface of the inner pane is designated as side III. The interior-side surface of the outer pane and the outer-side surface of the inner pane face one another.

According to the invention, at least one reflective layer for reflecting light is arranged on the outer-side surface and/or on the interior-side surface of the inner pane. Thus, a single reflective layer can be provided, which is arranged on the outer-side surface of the inner pane or on the interior-side surface of the inner pane. Alternatively, two reflective layers can be provided which are arranged on the outer-side surface and on the interior-side surface of the inner pane.

When the laminated pane is installed in a vehicle, the reflective layer is at a smaller distance from the vehicle interior than the masking layer, so that the imaging unit of a projection arrangement arranged in the vehicle interior has a direct view of the reflective layer and the reflective layer can reflect light emitted by the imaging unit (virtual image).

The reflective layer is arranged in a region of the laminated pane which, when viewed perpendicularly through the laminated pane, lies completely within the region in which the masking layer and the electrically switchable functional film are arranged. The reflective layer is therefore arranged when viewed perpendicularly through the laminated pane or in an orthogonal projection through the laminated pane so as to cover or overlap the combination of masking layer and electrically switchable functional film. In other words, the reflective layer therefore has no portion that does not overlap the combination of masking layer and electrically switchable functional film, i.e., the reflective layer is only formed where it is located in front of the combination of masking layer and electrically switchable functional film when viewed from the inside of the laminated pane. This ensures a high contrast and brightness and thus a good visibility of the virtual image reflected by the reflective layer, in particular when the electrically switchable functional film is in the first switching state (opaque).

The reflective layer serves to reflect light. The reflective layer is preferably light-impermeable or partially transparent, which within the purposes of the invention is understood to mean that it has an average transmission (according to ISO 9050:2003) in the visible spectral range of preferably at most 80%, particularly preferably at most 50%, and in particular less than 10%. The reflective layer preferably reflects at least 10%, particularly preferably at least 50%, and very particularly preferably at least 80%, and in particular at least 90% of the light impinging upon the reflective layer. The reflective layer preferably reflects p-polarised and s-polarised light in equal proportions, but it can also reflect p-polarised light and s-polarised light to different degrees. In one embodiment, the light reflected by the reflective layer predominantly comprises p-polarised light, so that the virtual image is clearly visible even when using s-polarising sunglasses. Methods for measuring the light reflection are known to a person skilled in the art. In this case, a light source (standard light source A) and a detector are arranged on the same side of the reflective layer, wherein the reflected light is detected by the detector. For example, the light from the light source hits the reflection surface at an angle of 80° to the normal.

The light reflected by the reflective layer is preferably visible light, i.e., light in a wavelength range of approximately 380 nm to 780 nm. The reflective layer preferably has a high and uniform reflectance (via different irradiation angles) to p-polarised and/or s-polarised radiation, so that a strong and colour-neutral image presentation is ensured.

The indication of the polarisation direction refers to the plane of incidence of the radiation on the laminated pane. P-polarised radiation refers to a radiation the electric field of which oscillates in the plane of incidence. S-polarised radiation refers to a radiation the electric field of which oscillates perpendicular to the plane of incidence. The plane of incidence is spanned by the incident vector and the surface normal of the laminated pane in the geometric centre of the irradiated region.

In other words, the polarisation, i.e., in particular, the proportion of p- and s-polarised radiation, is determined at a point of the region irradiated by the image display device-preferably in the geometric centre of the irradiated region. Because laminated panes can be curved (for example, when formed as a windshield), which has effects upon the plane of incidence of the image display device radiation, polarisation components slightly deviating therefrom can occur in the other regions, which is unavoidable for physical reasons.

In a preferred embodiment of the invention, the reflective layer is a metallic layer, i.e., a layer which contains or consists of metal.

The reflective layer preferably contains at least one metal selected from a group consisting of aluminium, magnesium, tin, indium, titanium, tantalum, niobium, nickel, copper, chromium, cobalt, iron, manganese, zirconium, cerium, scandium, yttrium, silver, gold, platinum and palladium, ruthenium or mixtures thereof. Aluminium, titanium, and/or nickel are preferred because they can have a high reflection for p-polarised or s-polarised light. Aluminium in particular is preferred.

The reflective layer preferably has a thickness of 10 nm (nanometers) to 100 μm (micrometers), particularly preferably 50 nm to 50 μm, in particular 100 nm to 5 μm.

In a particularly preferred embodiment of the invention, the reflective layer is a coating containing a thin-film stack, i.e., a layer sequence of thin individual layers. This thin-film stack contains one or more electrically conductive layers based on nickel, titanium, and/or aluminium. The electrically conductive layer based on nickel, titanium, and/or aluminium gives the reflective layer basic reflective properties and also an IR-reflecting effect and an electrical conductivity. The electrically conductive layer is based on nickel, titanium, and/or aluminium. The conductive layer preferably contains at least 90 wt. % nickel, titanium and/or aluminium, particularly preferably at least 99 wt. % aluminium, and very particularly preferably at least 99.9 wt. % nickel, titanium, and/or aluminium. The layer based on aluminium, nickel and/or titanium can have doping, for example, palladium, gold, copper, or silver. Materials based on aluminium, nickel, and/or titanium are particularly suitable for reflecting light, and particularly preferably p-polarised light. The use of nickel, titanium, and/or aluminium in metallic coatings has proven to be particularly advantageous in the reflection of light. Aluminium, nickel, and/or titanium are significantly cheaper than many other metals, such as gold or silver. The individual layers of the thin-film stack preferably have a thickness of 10 nm to 1 μm. The thin-film stack preferably has 2 to 20 individual layers and in particular 5 to 10 individual layers.

As described above, at least one masking layer is arranged in the laminated pane according to the invention. The masking layer is preferably arranged in an edge region of the laminated pane, which is typically adjacent to the pane edge of the pane. The great advantage of this arrangement is obtained when using the laminated pane in a vehicle as a windshield, because the masking layer lies outside the main viewing area of the driver when arranged in an edge region.

The masking layer is preferably arranged at least along the lower edge and adjacent to the lower edge. This results in a rectangular opaque strip, which is arranged along the lower edge, when looking onto the laminated pane.

In a particular embodiment of the laminated pane according to the invention, the masking layer is designed to run circumferentially in a frame-like manner. In a portion in which the reflective layer is arranged to overlap the masking layer, the frame-like masking layer is provided, for example, with a widening, i.e., it has a greater width (dimension perpendicular to the extension) than in other portions. In this way, the masking layer (in combination with the electrically switchable functional film) can be suitably adapted to the dimensions of the reflective layer. In one embodiment, the masking layer is designed to run circumferentially in a frame-like manner and, in particular in a portion which overlaps the reflective layer, has a greater width than in portions different therefrom.

For example, the reflective layer substantially has the shape of a rectangle that extends in a region near the lower edge between the two side edges. For example, the edges of the reflective layer do not reach the side edges and the lower edge, but instead are, for example, 2 cm to 5 cm distant therefrom.

The masking layer within the purposes of the invention is a layer that prevents viewing through the laminated pane. In this case, a transmission of less then 5%, preferably less than 1.5%, in particular at most 0.1% of the light of the visible spectrum is transmitted through the masking layer. The masking layer is thus an opaque masking layer, preferably a black masking layer. Methods for measuring the light transmission are known to a person skilled in the art. Here, a light source (standard light source A) is arranged on one side of the masking layer and a detector on the other side of the masking layer, wherein the transmitted light is detected by the detector.

The masking layer is preferably a coating made up of one or more layers. Alternatively, the masking layer can also be a coloured region of the thermoplastic intermediate layer. According to a preferred embodiment of the laminated pane, the masking layer consists of a single layer. This has the advantage of a particularly simple and cost-effective manufacture of the laminated pane because only a single layer has to be formed for the masking layer. The masking layer is in particular an opaque masking print made of a dark, preferably black, enamel.

Advantageously, the masking layer is designed as an opaque masking print arranged on the interior-side surface (side II) of the outer pane, in particular made of a dark, preferably black, enamel. Alternatively or additionally, the masking layer is designed as an opaque masking print arranged on the outer-side surface (side III) of the inner pane, in particular made of a dark, preferably black, enamel. In particular, a first opaque masking print can be arranged on the interior-side surface (side II) of the outer pane and a second opaque masking print on the outer-side surface (side III) of the inner pane.

In an alternative embodiment, the masking layer is designed as an opaquely coloured region of the thermoplastic intermediate layer. In one embodiment, the thermoplastic intermediate layer is formed in one piece and is opaquely coloured in a region.

A masking layer formed as an opaquely coloured region of the thermoplastic intermediate layer can also be realised in which a thermoplastic intermediate layer composed of an opaque thermoplastic functional film and a transparent thermoplastic functional film is used. The transparent and the opaque functional film consist of the same plastics or preferably contain the same plastics. The materials on the basis of which the opaque functional film and the transparent functional film can be formed are those which are also described for the thermoplastic intermediate layer. The opaque functional film is preferably a coloured functional film which can have different colours, in particular black.

In one embodiment of the laminated pane according to the invention, a reflective layer for reflecting light is arranged on the interior-side surface of the glass pane and a protective layer is arranged on this reflective layer. The protective layer is preferably transparent and applied in a planar manner, in particular congruently, to the reflective layer. The protective layer is preferably a polymer based on polyacrylates, polyoximes, alkyd resins, polyurethanes or mixtures thereof. The protective layer preferably has a thickness of 50 nm to 10 μm and particularly preferably of 100 nm to 5 μm. The protective layer protects the reflective layer from mechanical damage, such as scratches. It can also serve to increase the durability of the reflective layer.

In a preferred embodiment of the invention, the protective layer is a layer that is easy to clean and/or an “anti-fingerprint” layer. For the purposes of the invention, “layer that is easy to clean” is understood to mean that dirt in the form of, for example, fingerprints, grease spots and dirt particles on the protective layer can be removed from the protective layer by using a cloth and preferably a microfiber cloth. Grease-dissolving or abrasive cleaning agents and solvents, for example based on alcohols, are therefore largely avoided for the cleaning of the protective layer. For the purposes of the invention, “anti-fingerprint layer” is understood to mean a layer in which fingerprints that adhere to the protective layer are hardly or not at all perceptible visually. The term “fingerprints” refers in particular to the grease-containing components of a human finger that remain on a surface when a surface is touched and can be unaesthetic.

The laminated pane is preferably curved in one or more spatial directions, as is usual for motor vehicle panes, wherein the typical radii of curvature are in a range of approximately 10 cm to approximately 40 m. However, the laminated pane can also be flat, for example if it is provided as a pane for buses, trains or tractors.

The thermoplastic intermediate layer, via which the outer pane is joined to the inner pane, contains at least one thermoplastic polymer, preferably ethylene vinyl acetate (EVA), polyvinyl butyral (PVB) or polyurethane (PU), or mixtures, or copolymers, or derivatives thereof, particularly preferably PVB. The thermoplastic intermediate layer is typically formed from a thermoplastic functional film (joining film). The thickness of the thermoplastic intermediate layer is preferably from 0.2 mm to 2 mm, particularly preferably from 0.3 mm to 1 mm, for example 760 μm. The thermoplastic intermediate layer may be formed by a single film or also by more than one film. The thermoplastic intermediate layer can also be a film with functional properties, for example a film with acoustic damping properties.

The outer pane and the inner pane preferably contain or consist of glass, particularly preferably flat glass, float glass, quartz glass, borosilicate glass, soda-lime glass, alumino silicate glass, or clear plastics, preferably rigid clear plastics, in particular polyethylene, polypropylene, polycarbonate, polymethyl methacrylate, polystyrene, polyamide, polyester, polyvinyl chloride, and/or mixtures thereof.

The outer pane and the inner pane can be clear and colourless, but also tinted or coloured. In a preferred embodiment, the total transmission through the windshield is greater than 70% in the main see-through region (light type A). The term “total transmission” relates to the method defined by ECE-R 43, Annex 3, Section 9.1 for testing the light transmittance of motor vehicle panes. Independently of one another, the outer pane and the inner panes can be not prestressed, partially prestressed or prestressed. If at least one of the panes is to be prestressed, this can be thermal or chemical prestressing.

The thickness of the outer pane and of the inner pane can vary widely and accordingly be adapted to the requirements in the individual case. The outer pane and the inner pane preferably have thicknesses of 0.5 mm to 5 mm, particularly preferably of 1 mm to 3 mm, very particularly preferably of 1.6 mm to 2.1 mm. For example, the outer pane has a thickness of 2.1 mm, and the inner pane has a thickness of 1.6 mm. However, the outer pane or, in particular, the inner pane can also be a thin glass with a thickness of 0.55 mm, for example.

The laminated pane according to the invention may comprise one or more additional intermediate layers, in particular functional intermediate layers. An additional intermediate layer can be, in particular, an intermediate layer with acoustically damping properties, an intermediate layer reflecting infrared radiation, an intermediate layer absorbing infrared radiation, an intermediate layer absorbing UV radiation, a layer that is coloured at least in portions, and/or an intermediate layer that is tinted at least in portions. If there is a plurality of additional intermediate layers, they can also have different functions.

The invention also relates to a projection arrangement which comprises a laminated pane according to the invention and an imaging unit directed onto the reflective layer.

Also according to the invention, therefore, is a projection arrangement which comprises:
a laminated pane, comprising an outer pane with an outer-side surface and an interior-side surface, a thermoplastic intermediate layer, an inner pane with an outer-side surface and an interior-side surface, at least one masking layer which is arranged between the outer pane and the inner pane, at least one electrically switchable functional film, which can be switched between a first switching state with lower optical transmission and a second switching state with higher optical transmission by applying an operating voltage, wherein the electrically switchable functional film is arranged, when viewed perpendicularly through the laminated pane, directly adjacent to the masking layer or overlapping an opening in the masking layer, wherein the masking layer and the electrically switchable functional film are arranged in one region of the laminated pane, at least one reflective layer for reflecting light on the outer-side surface and/or on the interior-side surface of the inner pane, wherein the reflective layer is arranged, when viewed perpendicularly through the laminated pane, completely within the region of the laminated pane in which the masking layer and the electrically switchable functional film are arranged,
and an imaging unit directed at the reflective layer.

The reflective layer with the masking layer behind it from the perspective of a vehicle occupant in combination with the electrically switchable functional film ensures good visibility of the virtual image in a projection arrangement according to the invention, even when there is external sunlight and when using low-light imaging units. Even under these circumstances, the image generated by the imaging unit appears bright and can be seen perfectly. This enables a reduction in the power of the imaging unit and thus a reduced energy consumption.

From the perspective of a vehicle occupant, the reflective layer is arranged spatially in front of the combination of masking layer and electrically switchable functional film when viewed through the inner pane. As a result, the region of the laminated pane in which the reflective layer is arranged appears opaque. The expression “when viewed through the laminated pane” is understood to mean looking through the laminated pane starting from the interior-side surface of the laminated pane. The expression “spatially in front of,” as used in the present invention, is understood to mean that the reflective layer is arranged spatially further away from the outer-side surface of the outer pane than the masking layer and the electrically switchable functional film.

The imaging unit of the projection arrangement emits light and is arranged in the vicinity of the interior-side surface of the inner pane such that the imaging unit irradiates this surface, wherein the light is reflected by the reflective layer of the laminated pane. The reflective layer preferably reflects at least 10%, particularly preferably at least 50%, very particularly preferably at least 80%, and in particular at least 90% of the incident light on the reflective layer in a wavelength range of 400 nm to 700 nm and irradiation angles of 55° to 80°. This is advantageous in order to achieve the highest possible brightness of an image emitted by the imaging unit and reflected on the reflective layer.

The imaging unit serves to emit an image and can thus also be referred to as a projector, display device or image display device. A display or other device known to a person skilled in the art, for example, can be used as the imaging unit. The imaging unit is preferably a display, particularly preferably an LCD display, LED display, OLED display or electroluminescent display, in particular an LCD display. Displays have a low installation height and are thus simply integrated into the dashboard of a vehicle in a space-saving manner. Moreover, displays can be operated in a significantly more energy-saving manner than other imaging units. The comparatively lower brightness of displays is completely sufficient in the combination according to the invention of the reflective layer with the underlying masking layer and electrically switchable functional film. The radiation of the imaging unit preferably impinges in the region of the reflective layer at an angle of incidence of 55° to 80° preferably of 62° to 77° on the laminated pane. The incidence angle is the angle between the incidence vector of the radiation of the image display device and the surface normal in the geometric centre of the reflective layer.

The imaging unit is advantageously designed in such a way that either the complete region consisting of the masking layer and the electrically switchable functional film (when viewed perpendicularly through the laminated pane) or only the region of the masking layer alone is freely used for reflection on the reflective layer. In other words, the image can be generated by the imaging unit in such a way that it is reflected by the reflective layer in a region that overlaps the combination of masking layer and electrically switchable functional film (in a perpendicular view through the laminated pane). The image is therefore also reflected by a region of the reflective layer that overlaps the electrically switchable functional film (when viewed perpendicularly through the laminated pane). In this case, the electrically switchable functional film is in the first switching state (opaque). On the other hand, the imaging unit can generate the image in such a way that it is reflected by the reflective layer in a region that only overlaps the masking layer and therefore does not overlap the electrically switchable functional film (when viewed perpendicularly through the laminated pane). In this case, the electrically switchable functional film can be in the second switching state (transparent).

The designs of the laminated pane according to the invention described above also correspondingly apply to the projection arrangement according to the invention and vice versa.

According to the invention, there is a method for producing a laminated pane according to the invention comprising:
a) providing an outer pane with an outer-side surface (I) and an interior-side surface (II), a thermoplastic intermediate layer and an inner pane with an outer-side surface (III) and an interior-side surface (IV);
b) steps i) to iii):
i) forming at least one masking layer which is arranged between the outer pane and the inner pane, and
ii) arranging at least one electrically switchable functional film which can be switched between a first switching state with lower optical transmission and a second switching state with higher optical transmission by applying an operating voltage, such that it is arranged directly adjacent to the masking layer or overlapping an opening in the masking layer when viewed perpendicularly through the laminated pane, wherein the masking layer and the electrically switchable functional film are arranged in one region of the laminated pane, and
iii) forming at least one reflective layer for reflecting light on the outer-side surface (III) and/or on the interior-side surface (IV) of the inner pane, wherein the reflective layer is formed, when viewed perpendicularly through the laminated pane, completely within the region of the laminated pane in which the masking layer and the electrically switchable functional film are arranged,
c) connecting the outer pane and the inner pane via the thermoplastic intermediate layer, wherein the thermoplastic intermediate layer is arranged between the outer pane and the inner pane.

The steps can be performed in the order given, simultaneously, or in a different order. Step c) occurs after steps a) and b).

If the laminated pane is to be curved, a curved outer pane and a curved inner pane are inserted in step a). The lamination is produced in step c) by means of lamination methods familiar to a person skilled in the art. When producing the reflective layer in step b), the reflective layer can be applied by means of generally known coating methods, such as magnetron sputtering or cold gas spraying.

The embodiments of the laminated pane according to the invention described above also correspondingly apply to methods for producing a laminated pane according to the invention.

The invention also relates to the use of a laminated pane according to the invention as a vehicle pane in means of transport for traffic on land, in the air or on water, in particular in motor vehicles and in particular as a windshield for a head-up display.

The various embodiments of the invention may be implemented individually or in any combinations. In particular, the features mentioned above and to be explained below can be used not only in the specified combinations, but also in other combinations or alone without departing from the scope of the present invention.

The invention is explained in more detail below with reference to exemplary embodiments, wherein reference is made to the accompanying figures. In a simplified, not-to-scale representation:

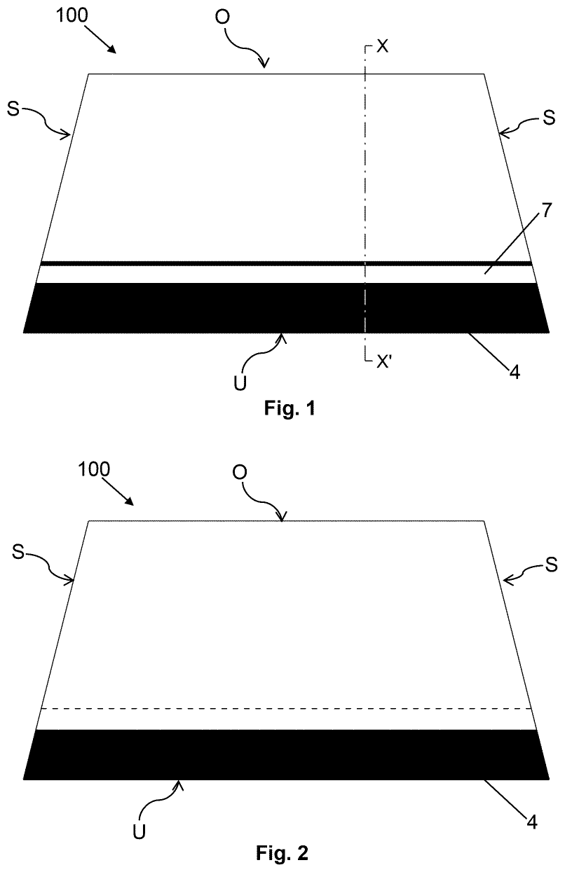

FIG. 1 is a plan view of an embodiment of the laminated pane according to the invention,

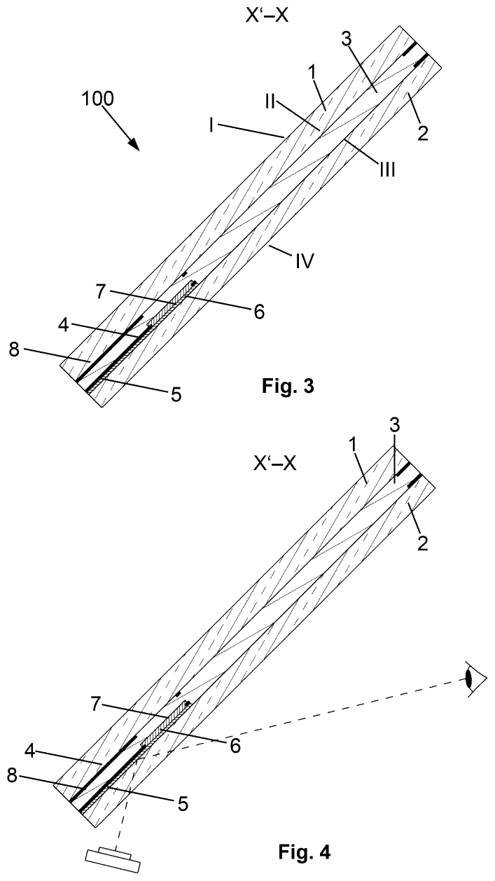

FIG. 2 is a plan view of a further embodiment of the laminated pane according to the invention,

FIG. 3 shows a cross section through the embodiment shown in FIG. 1,

FIG. 4 shows a cross section through an embodiment of the projection arrangement according to the invention,

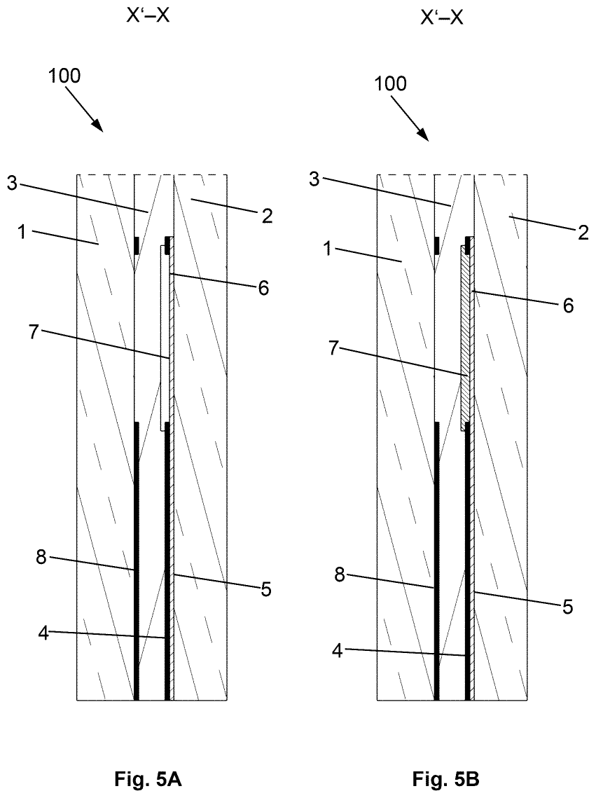

FIG. 5A shows a cross section through the embodiment shown in FIG. 1 with an electrically switchable functional film in the transparent switching state,

FIG. 5B shows a cross section through the embodiment shown in FIG. 1 with an electrically switchable functional film in the opaque switching state,

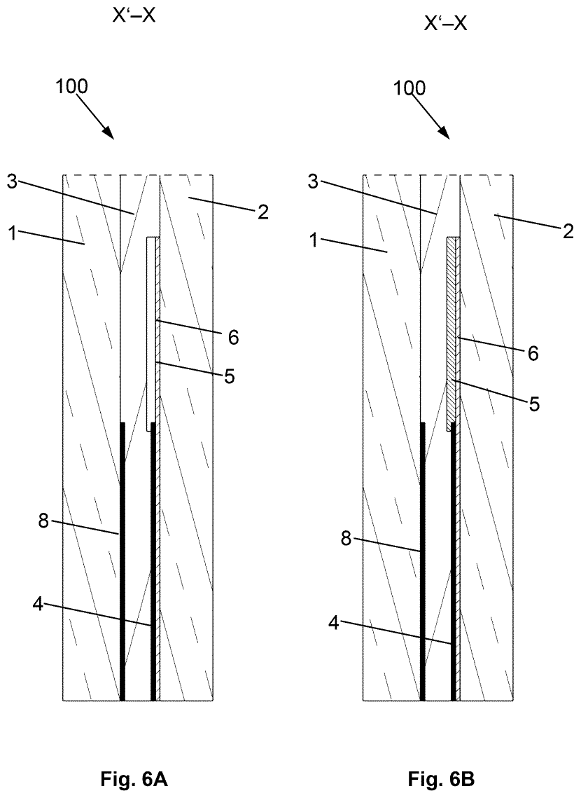

FIG. 6A shows a cross section through the embodiment shown in FIG. 2 with an electrically switchable functional film in the transparent switching state,

FIG. 6B shows a cross section through the embodiment shown in FIG. 2 with an electrically switchable functional film in the opaque switching state,

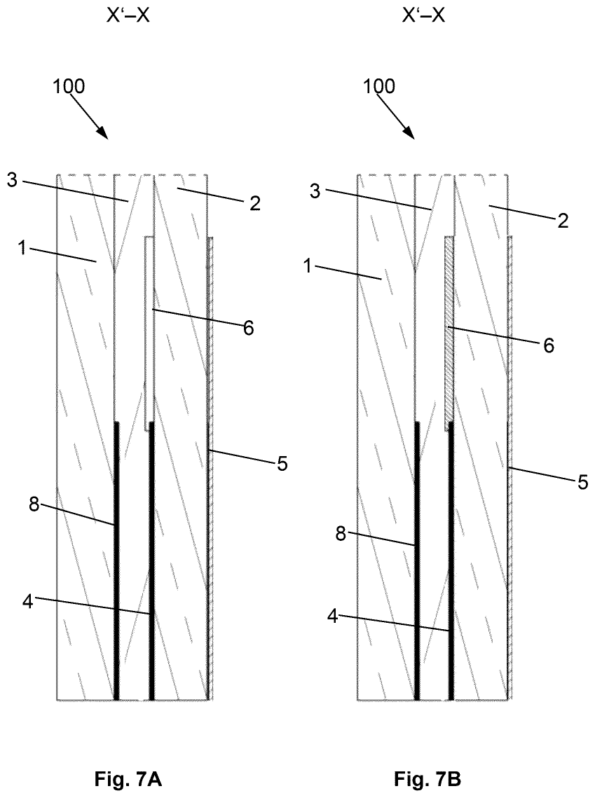

FIG. 7A shows a cross section through a further embodiment with an electrically switchable functional film in the transparent switching state,

FIG. 7B shows a cross section through a further embodiment with an electrically switchable functional film in the opaque switching state,

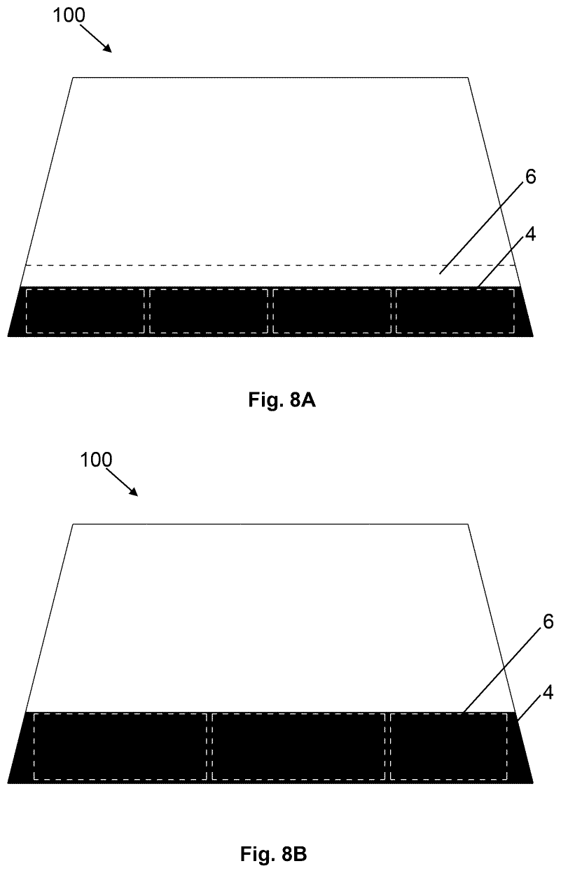

FIG. 8A is a plan view of the embodiment of the laminated pane according to the invention of FIG. 2 with electrically switchable functional film in the transparent switching state,

FIG. 8B is a plan view of the embodiment of the laminated pane according to the invention of FIG. 2 with electrically switchable functional film in the opaque switching state,

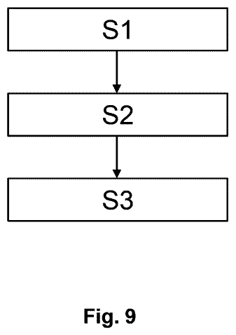

FIG. 9 shows an exemplary embodiment of the method according to the invention with the aid of a flow chart.

FIGS. 1 and 2 each show a plan view of an embodiment of the laminated pane 100 according to the invention, and in FIG. 3 the cross section through the laminated pane 100 shown in FIG. 1 along the cutting line X-X′ is depicted.

The laminated pane 100 shown in FIGS. 1 and 2 has an upper edge O, a lower edge U and two side edges S. Furthermore, the laminated pane 100 comprises an outer pane 1 with an outer-side surface I and an interior-side surface II, an inner pane 2 with an outer-side surface III and an interior-side surface IV, a thermoplastic intermediate layer 3, a first masking layer 4 and a second masking layer 8. The thermoplastic intermediate layer 3 is arranged between the outer pane 1 and the inner pane 2. The outer pane 1, the thermoplastic intermediate layer 3 and the inner pane 2 are arranged stacked over one another over the entire surface. The first masking layer 4 is arranged between the thermoplastic intermediate layer 3 and the inner pane 2 in a region of the laminated pane 100 whose surface coverage is smaller than the surface coverage of the laminated pane 100, i.e., the first masking layer 4 does not extend over the entire surface of the laminated pane 100. The second masking layer 8 is arranged between the thermoplastic intermediate layer 3 and the outer pane 1 in a region of the laminated pane 100 whose surface coverage is smaller than the surface coverage of the laminated pane 100, i.e., the second masking layer 8 does not extend over the entire surface of the laminated pane 100. In the embodiment shown in FIGS. 1 and 2, the two masking layers 4, 8 are each formed as an opaque masking print and are arranged only in an edge region of the laminated pane 100 adjacent to the lower edge U. In the embodiment shown in FIGS. 1 and 2, the two masking layers 4, 8 extend between the two side edges S of the laminated pane 100 and, starting from the lower edge U of the laminated pane 100, have a width of, for example, 30 cm.

The laminated pane 100 further comprises an electrically switchable functional film 6, which can be switched between a first switching state with lower optical transmission (opaque) and a second switching state with higher optical transmission (transparent) by applying an operating voltage. In FIG. 1, the electrically switchable functional film 6 is arranged, when viewed perpendicularly through the laminated pane 100 to (completely) overlap an opening 7 of the first masking layer 4. The opening 7 of the first masking layer 4 can be made opaque by the electrically switchable functional film 6 in the first switching state. In FIG. 2, the electrically switchable functional film 6 is arranged directly adjacent to the first masking layer 4 when viewed perpendicularly through the laminated pane 100 in order to increase the opaque region of the laminated pane 100 (without gaps). In FIG. 2, the first masking layer 4 has no opening. In other words, the first masking layer 4 and the electrically switchable functional film 6 are used in combination to freely change the size of the opaque region of the laminated pane 100 as desired. In the first switching state of the electrically switchable functional film 6, the opaque region of the laminated pane 100 results from the combination of the opaque regions of the first masking layer 4 and the electrically switchable functional film 6, based on a perpendicular view through the laminated pane 100. In the second switching state, the opaque region of the laminated pane 100 is formed by the first masking layer 4 alone. In FIGS. 1 and 2, the electrically switchable functional film 6 is in each case in the transparent switching state.

The electrically switchable functional film 6 is a guest-host functional film, an electrochromic functional film, an SPD functional film or a PDLC functional film. Typical values for the optical transparency (TL) and typical haze values of electrically switchable functional films are shown in the following table:

| | TL values | haze values |
|---|---|---|
| guest-host film | opaque 1.5% | opaque 4% |
| | transparent 35% | transparent 2% |
| electrochromic film | opaque 1.5% | opaque and |
| | transparent 30% | transparent <2% |
| SPD film | opaque 1% | opaque 35-40% |
| | transparent 40% | transparent 4% |

Furthermore, the laminated pane 100 comprises a reflective layer 5 for reflecting light on the outer-side surface (III) of the inner pane 2, wherein the reflective layer 5 is arranged, when viewed perpendicularly through the laminated pane 100, completely within the region of the laminated pane 100 in which the first masking layer 4 and the electrically switchable functional film 6 are arranged.

FIG. 3 shows a modification of the embodiment of FIG. 1, in which the two masking layers 4, 8 are each designed to run circumferentially in a frame-like manner, wherein the width of the region of the masking layers 4, 8 which is arranged to overlap the reflective layer 5 (when viewed perpendicularly through the laminated pane 100) is wider than the remaining part of the masking layers 4, 8. In FIGS. 1 and 2, the frame-like perimeter of the masking layer 4 is not shown for the sake of simplicity.

The thermoplastic intermediate layer 3 contains PVB, for example, and has a thickness of 0.76 mm. The outer pane 1 consists, for example, of soda lime glass and is 2.1 mm thick. The inner pane 2 consists, for example, of soda lime glass and is 1.6 mm thick.

It should be understood that the laminated pane 100 can have any suitable geometric shape and/or curvature. Typically, the laminated pane 100 is a curved laminated pane. The laminated pane 100 is, for example, the windshield of a motor vehicle.

FIG. 4 shows a cross section through an embodiment of the projection arrangement 101 according to the invention. The projection arrangement 101 shown in FIG. 4 comprises a laminated pane 100 and an imaging unit 9. The imaging unit 9 is used to generate p-polarised light and/or s-polarised light (image information), which is directed onto the reflective layer 5 and is reflected by the reflective layer 5 as reflected light into the vehicle interior where it can be perceived by a viewer, e.g., a driver. The reflective layer 5 is suitably designed to reflect the light of the imaging unit 9. The light preferably impinges on the reflective layer 5 at an angle of incidence of 55° to 80°, in particular of 62° to 77°. The imaging unit 9 is, for example, a display, in particular an LCD display. Preferably, the imaging unit 9 serves to generate only p-polarised light, which can be seen well, in particular, with polarising sunglasses that have an s-polarisation filter.

The imaging unit 9 is designed such that the image is directed onto the reflection surface 5 in such a way that either a region of the reflective layer 5 that overlaps the region of the first masking layer 4 and the electrically switchable functional film 6 or a region of the reflective layer 5 that only overlaps the first masking layer 4 is freely used for reflection (when viewed perpendicularly through the laminated pane 100).

FIG. 5A shows a cross section through the embodiment shown in FIG. 1, wherein the electrically switchable functional film 6 is in the transparent switching state (no operating voltage applied). In this case, the opaque region of the laminated pane 100 is reduced to the first masking layer 4, i.e., the opening 7 is transparent. The image generated by the imaging unit 9 is generated in such a way that it is reflected by the reflective layer 5 in a region that only overlaps the first masking layer 4 and therefore does not overlap the electrically switchable functional film 6 (when viewed perpendicularly through the laminated pane).

FIG. 5B shows a cross section through the embodiment shown in FIG. 1, wherein the electrically switchable functional film 6 is in the opaque switching state (operating voltage applied). In this case, the opaque region of the laminated pane 100 results from the first masking layer 4 in combination with the electrically switchable functional film 6, i.e., the entire opening 7 is opaque. The image generated by the imaging unit 9 is generated in such a way that it is reflected by the reflective layer 5 in a region that overlaps the combination of the first masking layer 4 and the electrically switchable functional film 6 (when viewed perpendicularly through the laminated pane 100).

In the embodiment of FIG. 1, in which the two masking layers 4, 8 each have an opening, the part of the masking layers 4, 8 located closer to the upper edge O can be used to arrange electrical connections of the electrically switchable functional film 6 in a concealed manner.

FIGS. 7A and 7B show further embodiments of the laminated pane 100 according to the invention. The embodiment shown in cross section in FIG. 7A (analogous to FIG. 6A) differs from that shown in FIG. 6A only in that the reflective layer 5 is arranged not on the outer-side surface (side III) of the inner pane 2, but on the interior-side surface (side IV) of the inner pane 2. The embodiment shown in cross section in FIG. 7B (analogous to FIG. 6B) differs from that shown in FIG. 6B only in that the reflective layer 5 is arranged not on the outer-side surface (side III) of the inner pane 2, but on the interior-side surface (side IV) of the inner pane 2. In FIGS. 7A and 7B, the electrically switchable functional film 6 is again shown in the transparent switching state (FIG. 7A) and in the opaque switching state (FIG. 7B).

FIGS. 8A and 8B illustrate the change in the size of the opaque region of the laminated pane 100 based on a plan view of the embodiment of the laminated pane according to the invention from FIG. 2. In FIG. 8A, the electrically switchable functional film 6 is in the transparent switching state; in FIG. 8B it is in the opaque switching state. The size of the opaque region of the laminated pane 100 can be changed in a simple manner by switching the electrically switchable functional film 6.

An exemplary embodiment of a method according to the invention is shown in FIG. 9 using a flow chart.

In a step S1, an outer pane 1 is provided with an outer-side surface I and an interior-side surface II, a thermoplastic intermediate layer 3 and an inner pane 2 are provided with an outer-side surface III and an interior-side surface IV.

In a step S2, which comprises multiple sub-steps,
at least one masking layer 4 is formed and is arranged between the outer pane 1 and the inner pane 2,
at least one electrically switchable functional film 6, which can be switched between a first switching state with lower optical transmission and a second switching state with higher optical transmission by applying an operating voltage, is arranged, when viewed perpendicularly through the laminated pane 100, directly adjacent to the masking layer 4 or overlapping an opening 7 in the masking layer 4, wherein the masking layer 4 and the electrically switchable functional film 6 are arranged in one region of the laminated pane 100,
at least one reflective layer 5 for reflecting light is formed on the outer-side surface (III) and/or on the interior-side surface (IV) of the inner pane 2, wherein the reflective layer 5 is formed, when viewed perpendicularly through the laminated pane 100, completely within the region of the laminated pane 100 in which the masking layer 4 and the electrically switchable functional film 6 are arranged,

In a step S3, the outer pane 1 and the inner pane 2 are connected via the thermoplastic intermediate layer 3, wherein the thermoplastic intermediate layer 3 is arranged between the outer pane 1 and the inner pane 2.

Steps S1, S2 and S3 may be performed in any order or simultaneously, wherein step S3 occurs after steps S1 and S2.

From the above, it follows that the invention provides an improved laminated pane in which the size of the opaque region of the laminated pane can be freely changed by switching at least one electrically switchable functional film. The image of a projector can thus be reflected by a differently sized region of the reflective layer, wherein the virtual image is visually well perceptible with sufficient brightness and high contrast, so that good visibility, in particular of safety-relevant information, is reliably ensured in all weather and lighting conditions. In particular, the opaque region of the laminated pane may be reduced freely to the opaque region of the masking layer if the largest possible see-through region through the laminated pane is desired. In addition, undesired secondary images can be avoided. In industrial series production, the laminated pane can be manufactured efficiently and cost-effectively, wherein the production of the laminated pane can be easily implemented in common manufacturing processes.

### LIST OF REFERENCE SIGNS

100 Laminated pane
101 Projection arrangement
1 Outer pane
2 Inner pane
3 Thermoplastic intermediate layer
4 First masking layer
Reflective layer
6 Functional film
7 Opening
8 Second masking layer
9 Imaging unit
O Upper edge of the laminated pane 100
U Lower edge of the laminated pane 100
S Side edge of the laminated pane 100
I Outer-side surface of the outer pane 1
II Interior-side surface of the outer pane 1
III Outer-side surface of the inner pane 2
IV Interior-side surface of the inner pane 2

1. A laminated pane, comprising:
an outer pane with an outer-side surface and an interior-side surface,
a thermoplastic intermediate layer,
an inner pane with an outer-side surface and an interior-side surface,
at least one masking layer, which is arranged between the outer pane and the inner pane,
at least one electrically switchable functional film which is switchable between a first switching state with lower optical transmission and a second switching state with higher optical transmission by applying an operating voltage, wherein the electrically switchable functional film is arranged, when viewed perpendicularly through the laminated pane, directly adjacent to the masking layer or overlapping an opening in the masking layer, wherein the masking layer and the electrically switchable functional film are arranged in one region of the laminated pane,
on the outer-side surface and/or on the interior-side surface of the inner pane, at least one reflective layer for reflecting light, wherein the reflective layer is arranged, when viewed perpendicularly through the laminated pane, completely within the region of the laminated pane in which the masking layer and the electrically switchable functional film are arranged.

2. The laminated pane according to claim 1, wherein the electrically switchable functional film has an optical transmission of less than 1.5% in the first switching state and an optical transmission of more than 30% in the second switching state.

3. The laminated pane according to claim 1, wherein the electrically switchable functional film is selected from a guest-host functional film, an electrochromic functional film, an SPD functional film and a PDLC functional film.

4. The laminated pane according to claim 1, wherein the reflective layer reflects at least 10% of visible light.

5. The laminated pane according to claim 1, wherein the reflective layer is a metallic layer.

6. The laminated pane according to claim 5, wherein the reflective layer contains or consists of aluminium, titanium and/or nickel.

7. The laminated pane according to claim 1, wherein the masking layer is designed to run circumferentially in a frame-like manner and has a greater width than in portions different therefrom.

8. The laminated pane according to claim 1, wherein the masking layer is formed as an opaque masking print arranged on the interior-side surface of the outer pane and/or on the outer-side surface of the inner pane.

9. The laminated pane according to claim 1, wherein the masking layer is formed as an opaquely coloured region of the first thermoplastic intermediate layer.

10. The laminated pane according to claim 1, wherein the laminated pane is a curved laminated pane.

11. A projection arrangement comprising:
a laminated pane according to claim 1, and
an imaging unit directed at the reflective layer.

12. A method for producing a laminated pane according to claim 1, comprising:
a) providing an outer pane with an outer-side surface and an interior-side surface, a thermoplastic intermediate layer and an inner pane with an outer-side surface and an interior-side surface;
b) forming at least one masking layer which is arranged between the outer pane and the inner pane, arranging at least one electrically switchable functional film, which is switchable between a first switching state with lower optical transmission and a second switching state with higher optical transmission, by applying an operating voltage, when viewed perpendicularly through the laminated pane, directly adjacent to the masking layer or overlapping an opening in the masking layer, wherein the masking layer and the electrically switchable functional film are arranged in a region of the laminated pane, and forming at least one reflective layer for reflecting light on the outer-side surface and/or on the interior-side surface of the inner pane, wherein the reflective layer is formed, when viewed perpendicularly through the laminated pane, completely within the region of the laminated pane in which the masking layer and the electrically switchable functional film are arranged,
c) connecting the outer pane and the inner pane via the thermoplastic intermediate layer, wherein the thermoplastic intermediate layer is arranged between the outer pane and the inner pane.

13. A method comprising providing the laminated pane according to claim 1 as a vehicle pane in a vehicle of transport for traffic on land, in the air or on.

14. The laminated pane according to claim 4, wherein the reflective layer reflects at least 50% of visible light.

15. The laminated pane according to claim 14, wherein the reflective layer reflects at least 80% of visible light.

16. The laminated pane according to claim 15, wherein the reflective layer reflects at least 90% of visible light.

17. The laminated pane according to claim 7, wherein, in a portion that overlaps the reflective layer, the masking layer has a greater width than in portions different therefrom.

18. The method according to claim 13, wherein the vehicle is a motor vehicle.

19. The method according to claim 18, wherein the laminated pane is a windshield for a head-up display.
